(19) United States
(12) Patent Application Publication
(10) Pub. No.: US 2021/0095839 A1
(43) Pub. Date: Apr. 1, 2021

(54) MOUNTING ASSEMBLY, PANEL LIGHT HAVING MOUNTING ASSEMBLY AND PANEL LIGHT COMBINATION

(71) Applicant: NanoGrid Limited, Hong Kong (CN)

(72) Inventors: Tomas RODINGER, Shenzhen (CN); Guoping KANG, Shenzhen (CN)

(73) Assignee: NanoGrid Limited, Hong Kong (CN)

(21) Appl. No.: 16/592,665

(22) Filed: Oct. 3, 2019

(30) Foreign Application Priority Data
Sep. 26, 2019 (CN) 201921623881.7

(51) Int. Cl. F21V 21/04; F21V 15/01; F21V 19/00; F21V 21/096

(52) U.S. Cl. CPC F21V 21/04; F21V 15/01; F21Y 2115/10; F21V 21/096; F21V 19/0055

(57) ABSTRACT

The present invention relates to a mounting assembly, a panel light having the mounting assembly and a panel light combination. The mounting assembly has a mounting member including a first surface connectable to a mounting position, a second surface opposite the first surface, and a generally circular ring-shaped first connecting portion formed by extending outwardly along the second surface. There is also provided with a base plate connected to the mounting member, with a middle portion of the base plate extending outwardly to form a second connecting portion detachably connected to the first connecting portion. The first connecting portion is further configured to be movably engaged with the second connecting portion such that the base plate can adjust a mounting angle relative to the mounting member.

### CROSS REFERENCE TO RELATED APPLICATION

This application claims priority from earlier filed Chinese Patent Application No. 201921623881.7 filed Sep. 26, 2019, contents of which are incorporated herein in its entirety.

### FIELD OF THE INVENTION

The present invention relates to the technical field of structures of lighting apparatus, and particularly to a mounting assembly, a panel light having the mounting assembly and a panel light combination having the panel lights.

### BACKGROUND OF THE INVENTION

LED panel lights achieve a uniform planar illumination effect after the light passes through a light guide plate with high transmittance, and exhibit good illumination uniformity, soft light, comfort and brightness; therefore, the LED panel lights have gradually become a mainstream indoor lighting fixture.

LED panel lights may also meet specific light-emitting demands and form specific light-emitting effects by splicing and combining. A conventional indoor light mounting manner is fixing or hanging a plurality of panel lights on a roof, a wall surface or a ceiling as a whole. A conventional outdoor light mounting manner is usually fixing a lighting apparatus on a corresponding wall by fasteners such as screws and bolts. Panel lights are however difficult to detach, and the conventional mounting manner makes it inconvenient, difficult or even impossible to adjust an angle between neighboring panel lights during the mounting. In the field, an improved panel light mounting assembly is needed to overcome the above defects and other defects that have been existing in the field.

### SUMMARY OF THE INVENTION

A plurality of embodiments of the present invention provides a mounting assembly for panel lights, which aims to solve the problems in the prior art that the panel lights are difficult to detach, and the angle of the panel lights cannot be easily adjusted during installation. Some inventive concepts of the present invention enable installation and detachment of panel lights with greater flexibility and convenience without damaging the panel lights. Some inventive concepts of the present invention also make it possible to conveniently adjust the angle between the panel lights.

An embodiment of the mounting assembly according to the present invention comprises:

a mounting member including a first surface connectable to a mounting position, a second surface opposite the first surface, and a generally circular ring-shaped first connecting portion formed by extending outwardly along the second surface; and

a base plate connected to the mounting member, a middle portion of the base plate extending outwardly to form a second connecting portion detachably connected to the first connecting portion;

wherein the first connecting portion is further configured to be movably engaged with the second connecting portion such that the base plate can adjust a mounting angle relative to the mounting member.

In some embodiments, an inner side surface of the first connecting portion may be formed with an annular groove, the second connecting portion may include a plurality of connecting members arranged in a circular ring pattern and at an interval, and the connecting members may extend outwardly to form bosses, wherein the bosses may be configured such that the base plate is snap-fitted in the annular grooves in a manner rotatable relative to the mounting member.

In some embodiments, an inner side surface of the second connecting portion is formed with an annular groove, the first connecting portion may include a plurality of connecting members arranged in a circular ring pattern and at an interval, and the connecting members extend outward to form bosses, wherein the bosses are configured such that the base plate is snap-fittable in the annular grooves in a manner that a position relative to the mounting member is adjustable.

In some embodiments, the mounting member may further be provided with a plurality of through slots corresponding to the plurality of connecting members, wherein the number of the through slots may be different from that of the connecting members, and when the second connecting portion is connected to the first connecting portion, front end portions of all the connecting members may extend through the corresponding through slots.

In some embodiments, a chamfer or fillet may be provided on both sides of the front end portions of the connecting members in a rotation direction of the base plate.

In some embodiments, the connecting members may be formed by extending vertically outward along a surface of the base plate, and the bosses may be formed by extending in a direction away from a center of the base plate along an external surface of the connecting members.

In some embodiments, the boss may comprise an upper slope and a lower slope disposed obliquely relative to a surface of the base plate.

In some embodiments, a plurality of limiting members may extend inwardly at an interval at an upper end of an inner surface of the first connecting portion, the limiting members may be configured to snap fit with the bosses, the plurality of limiting members are located on the same plane parallel to the second surface, and the annular grooves may be located between the plurality of limiting members arranged in a circular ring pattern and the second surface.

In some embodiments, the inner surface of the first connecting portion may be recessed inwardly to form the annular grooves, and the bosses may all be snap-fitted in the annular grooves.

In some embodiments, the second surface may further be provided with a first positioning ring, the second connecting portion further may comprise a second positioning ring connected to the first positioning ring, and a reinforcing assembly located between the second positioning ring and the plurality of connecting members.

In some embodiments, the first positioning ring may be concentric with the circular-ring shaped first connecting portion, and the second positioning ring may be concentric with a circular ring formed by the plurality of connecting members.

In some embodiments, the reinforcing assembly may comprise a reinforcing ring concentric with the second positioning ring and a plurality of reinforcing ribs may be located between the second positioning ring and the plurality of connecting members.

In some embodiments, the mounting member may comprise a disc-shaped main body portion and a wing that is connected to the main body portion and assists in detachment; the main body portion may provide the first surface and the second surface, and be provided with the first connecting portion.

In some embodiments, the first surface of the mounting member may be detachably mounted to the mounting position.

In some embodiments, the first surface of the mounting member may be detachably mounted to the mounting position in one of the following manners:

(1) attaching a double-sided adhesive tape on the first surface of the mounting member;

(2) fixing a first magnet on the first surface of the mounting member, and fixing a second magnet on the mounting position;

(3) applying an adhesive on at least one of the first surface and the mounting position; and

(4) disposing a nail, a screw or a bolt on one of the first surface and the mounting position, and a hole or a threaded hole mating therewith is formed on one of the first surface and the mounting position.

The present invention further provides a panel light comprising the above-mentioned mounting assembly.

In some embodiments, the panel light further comprises a back cover, a circuit board disposed in the back cover, a bracket supporting the circuit board, an LED electrically connected to the circuit board, and a touch thin film electrically connected to the circuit board.

In some embodiments, the touch thin film may be an aluminum foil paper thin film.

In some embodiments, the panel light may be at least one selected from a group consisting of a triangular panel light, a quadrilateral panel light, a hexagonal panel light and an octagonal panel light.

Compared with the prior art, the present invention is provided with the mounting member and the base plate in that, the first surface of the mounting member may be connected to the mounting position such as a roof, wall surface, or ceiling by magnetic attraction or bonding, and the first connecting portion extending on the second surface may be detachably connected to the second connecting portion on the base plate. Further, during the installation process, the mounting member may be fixedly connected to the mounting position in advance according to actual needs, and the mounting of the base plate may be achieved through the connection of the first connecting portion and the second connecting portion.

At the same time, the annular grooves formed on the inner side surface of the first connecting portion are snap-fitted with the bosses on the connecting members of the second connecting portion, and meanwhile the plurality of bosses may all slide within the annular grooves, thereby effecting rotation of the base plate relative to the mounting member to facilitate adjustment of the mounting angle.

### BRIEF DESCRIPTION OF PREFERRED EMBODIMENTS

In order to more clearly illustrate the technical solutions in embodiments of the present invention, figures are used. Obviously, the figures described below are only some embodiments illustrating the present invention. Those ordinary skilled in the art will appreciate that other figures may be obtained according to these figures without making any inventive efforts.

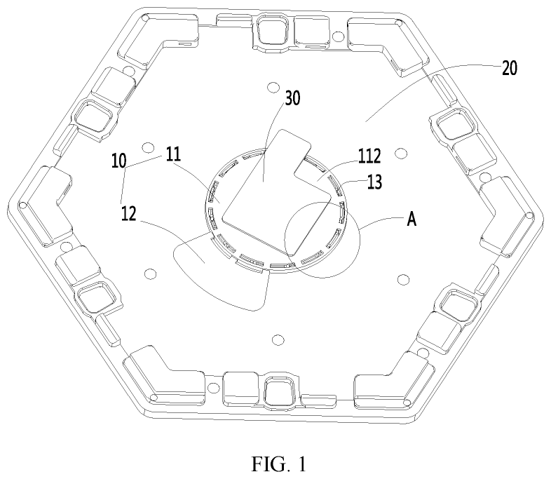

FIG. 1 is an embodiment illustrating a mounting assembly of the present invention, wherein a mounting member is connected to a base plate;

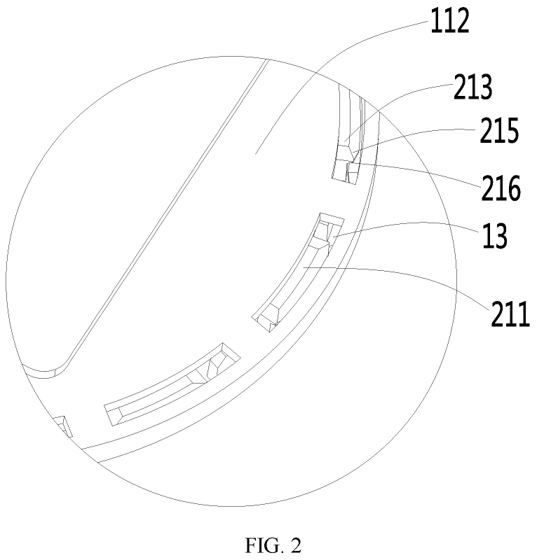

FIG. 2 is a partial enlarged view of a portion A of FIG. 1;

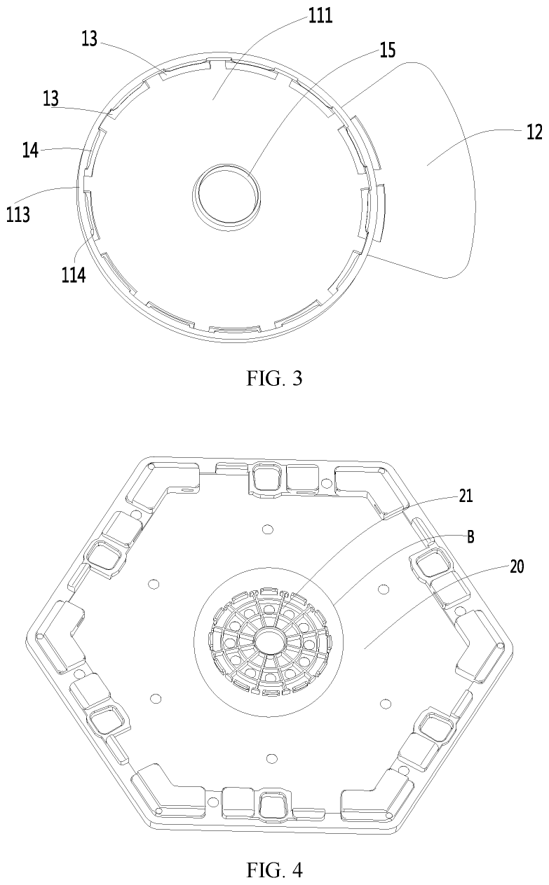

FIG. 3 is a structural view of a mounting member in a mounting assembly according to an embodiment of the present invention;

FIG. 4 is a structural view of a base plate in a mounting assembly according to an embodiment of the present invention;

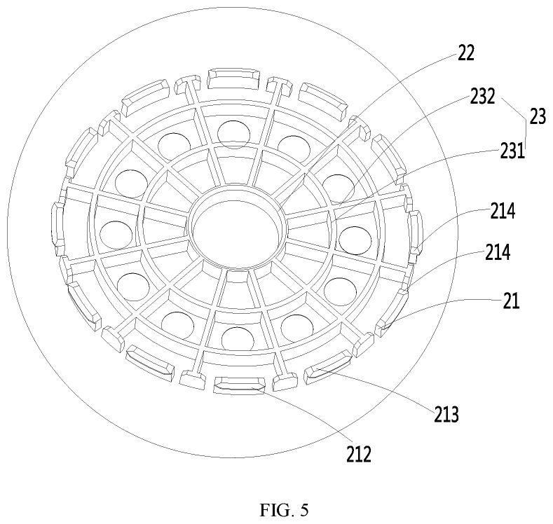

FIG. 5 is a partial enlarged view of a portion B of FIG. 4.

In the figures, the same reference numerals indicate the same features, specifically as follows:
10—mounting member; 11—main body portion; 12—wing; 111—first surface; 112—second surface; 113—first connecting portion; 114—annular groove; 13—through slot; 14—limiting piece; 15—first positioning ring;
20—base plate; 21—second connecting portion; 211—connecting member; 212—boss; 213—front end portion; 214—chamfer; 215—upper slope; 216—lower slope; 22—second positioning ring; 23—reinforcing assembly; 231—reinforcing ring; 232—reinforcing rib;
30—double-sided adhesive tape.

### DETAILED DESCRIPTION OF PREFERRED EMBODIMENTS

In order to illustrate the objects, technical solutions and advantages of the present invention more comprehensible, the present invention will be further described in detail below with reference to the figures and embodiments. It should be understood that the specific embodiments described herein are only used to illustrate the invention and are not intended to limit the scope of the invention.

It is to be appreciated that when an element is referred to as being “fixed” or “disposed” to another element, it may be directly or indirectly with respect to the another element. When an element is referred to as being “connected” to another element, it may be directly or indirectly connected to the another element.

It should be understood that orientation or position relations indicated by the terms “length”, “width”, “up”, “down”, “front”, “back”, “left”, “right”, “vertical”, “horizontal”, “top”, “bottom”, “in” and “out” are based on the orientation or position relations shown by the figures, are only intended to facilitate description of the invention and simplify description, not to indicate or imply that the referenced device or element must have a specific orientation or is configured and operated in a specific orientation, and therefore they cannot be understood as limiting the present invention.

Moreover, the terms “first” and “second” are used for descriptive purposes only and cannot be construed as indicating or implying a relative importance or implicitly indicating the number of technical features indicated. Thus, features defined with “first” and “second” may include one or more features either explicitly or implicitly. In the description of the present invention, “a plurality” means two or more unless otherwise specifically defined.

In an embodiment of the present invention, there is provided a mounting assembly, which is preferably used for mounting a panel light on a mounting position, wherein the mounting position may be a roof, a wall face, a ceiling, or other members or structures for mounting and fixing the panel light.

According to an embodiment of the present invention, referring to FIGS. 1-3, the mounting assembly comprises a mounting member 10 that preferably has a generally sheet-like shape. A material of the mounting member 10 is preferably a soft material to avoid damages to the mounting position when the mounting member is removed from the mounting position. The mounting member 10 comprises a first surface 111 connectable to the mounting position, a second surface 112 opposite the first surface 111, and a generally circular ring-shaped first connecting portion 113 formed by extending outwardly along the second surface 112.

According to an embodiment of the present invention, the mounting member 10 may be detachably mounted to the mounting position through the first surface 111. Specifically, according to an embodiment of the present invention, a double-sided adhesive 30 is attached to the first surface 111 of the mounting member 10, so that the mounting member 10 is bonded to the mounting position.

According to an embodiment of the present invention, a first magnet is fixed on the first surface 111 of the mounting member 10, and a second magnet is fixed on the mounting position; the mounting member 10 is mounted to the mounting position by magnetic attraction.

According to an embodiment of the present invention, an adhesive is applied on at least one of the first surface 111 and the mounting position, so that the mounting member 10 is mounted to the mounting position.

According to an embodiment of the present invention, a nail, a screw or a bolt is disposed on one of the first surface 111 and the mounting position, and a hole or a threaded hole mating therewith is formed on one of the first surface 111 and the mounting position. The mounting member 10 is mounted to the mounting position by means of threaded fitting.

Alternatively, the mounting member 10 be connected to the mounting position by magnetic attraction, or in other manners such as bonding connection.

According to an embodiment of the present invention, the first connecting portion 113 is preferably a circular ring-shaped structure, and may be simply changed by those skilled in the art into other implementable structural forms according to actual needs.

Referring to FIGS. 4-5, the mounting assembly further comprises a base plate 20. The base plate 20 is configured to be connected to the mounting member 10, thereby achieving the mounting of the panel light to the mounting position.

According to an embodiment of the present invention, referring to FIGS. 4-5, the base plate 20 is preferably disposed on a back cover of the panel light. According to an embodiment of the present invention, the base plate 20 is preferably integrally formed on the back cover of the panel light, and a back cover of the panel light is located on a side of the panel light opposite to a light exit direction thereof. In another embodiment of the present invention, the base plate 20 may be a separate member connected to the back cover of the panel light.

Referring to FIGS. 4-5, according to an embodiment of the present invention, the base plate 20 further has a second connecting portion 21 extending thereon. The second connecting portion 21 is preferably formed by extending outwardly along the middle of the base plate 20. The second connecting portion 21 is preferably detachably connected to the first connecting portion 113, thereby achieving detachable connection of the panel light to the mounting position.

According to one embodiment of the invention, the mounting member 10 is a separate member relative to the base plate. During the installation process, the mounting member 10 may first be bonded to the mounting position by a member similar to the double-sided tape 30 (shown in FIG. 1); then the base plate 20 is connected to the first connecting portion 113 via the second connecting portion 21 so that the base plate 20 may be mounted to the mounting position. In this embodiment, a plurality of mounting members 10 may be disposed at the mounting position in advance by bonding or magnetic attraction; and then the panel lamp provided with the foregoing base plate 20 on the back cover is connected to the mounting position through the connection of the second connecting portion 21 and the first connecting portion 113; a plurality of panel lights are mounted on the mounting position in a preset pattern.

According to one embodiment of the invention, the mounting member 10 is a separate member relative to the base plate. During the installation process, the mounting member 10 may be first connected to the base plate 20 through the connection of the second connecting portion 21 and the first connecting portion 113; at the same time, the double-sided adhesive tape is adhered to the first surface 111. Then, the panel light mounted with the mounting member 10 is bonded to the mounting position as needed.

Referring to FIGS. 1-3, according to an embodiment of the present invention, an inner side surface of the first connecting portion 113 is preferably formed with an annular groove 114. The second connecting portion 21 preferably comprises a plurality of connecting members 211 connectable to the annular groove 114. The plurality of the connecting members 211 are preferably arranged in a circular ring pattern and at an interval, and the connecting members 211 extends outward to form bosses 212. The plurality of bosses 212 are also arranged in a circular ring pattern such that when the second connecting portion 21 is coupled to the first connecting portion 113, the plurality of the bosses 212 are slidably connected in the annular groove 114 such that the base plate 20 is rotatable relative to the mounting member 10. Therefore, the panel light having the second connecting portion 21 is made rotatable relative to the mounting position to further adjust the relative angle of the panel light after the mounting of the panel light is completed. Or, the mounting relative angle is adjusted when the panel light is mounted.

According to another embodiment of the present invention, the structures of the first connecting portion and the second connecting portion may be interchanged, that is, the mounting angle of the mounting member 10 relative to the base plate 20 may also be achieved by disposing the second connecting portion on the mounting member 10, and disposing the first connecting portion on the base plate 20, without adjusting other structures.

In the present embodiment, the base plate 20 is preferably rotated relative to the mounting member 10 to achieve the adjustment of the mounting angle. Of course, other similar alternative adjustment manners are also within the scope of the present application.

Compared with the prior art, in the present invention, with the mounting member 10 and the base plate 20 being provided, the first surface 111 of the mounting member 10 may be connected to the mounting position such as a roof, wall surface, or ceiling by magnetic attraction or bonding. The first connecting portion 113 extending on the second surface 112 may be detachably connected to the second connecting portion 21 on the base plate 20. Further, during the installation process, the mounting member 10 may be fixedly connected to the mounting position in advance according to actual needs, and the mounting of the base plate 20 is achieved through the connection of the first connecting portion 113 and the second connecting portion 21.

At the same time, the annular grooves 114 formed on the inner side surface of the first connecting portion 113 are snap-fitted with the bosses 212 on the connecting members 211 of the second connecting portion 21, and meanwhile the plurality of bosses 212 may all slide within the annular grooves 114, thereby effecting rotation of the base plate 20 relative to the mounting member 10 to facilitate adjustment of the mounting angle of the panel light.

According to another embodiment of the present invention, the connecting member 211 on the second connecting portion 21 may also be configured as a circular ring-shaped member rotatably connected to the annular groove 114. Preferably, the circular ring-shaped member is provided with an annular boss 212 which is slidably connected in the annular groove 114, thereby achieving rotation of the base plate 20 relative to the mounting member 10 to facilitate adjustment of the mounting angle.

Referring to FIGS. 2-3, according to a further embodiment of the present invention, the circular ring-shaped member is provided with a plurality of bosses 212, and the plurality of bosses 212 are arranged on an external side surface of the circular ring-shaped member in a circular ring pattern, and are configured to be slidably connected in the annular grooves 114 to effect rotation of the base plate 20 relative to the mounting member 10 to facilitate adjustment of the mounting angle.

According to an embodiment of the present invention, referring to FIG. 3, it is preferable that the connecting member 211 are formed by extending vertically outward along a surface of the base plate 20, and the bosses 212 are formed by extending in a direction away from a center of the base plate 20 along an external surface of the connecting members 211. Furthermore, it is preferable that the boss 212 comprises an upper slope 215 and a lower slope 216 which are disposed obliquely relative to the surface of the base plate 20. This design facilitates the connection and detachment between the mounting member 10 and the base plate 20, thereby facilitating the mounting and detachment of the panel light relative to the mounting position.

Referring to FIG. 2-3, according to an embodiment of the present invention, the mounting member 10 is further provided with a plurality of through slots 13 corresponding to the plurality of connecting members 211. The number of the through slots 13 is different from that of the connecting members 211, and when the second connecting portion 21 is connected to the first connecting portion 113, all the front end portions 213 of the connecting members 211 extend through the corresponding through slots 13.

According to an embodiment of the present invention, the number of the through slots 13 is greater than that of the connecting members 211, and when the second connecting portion 21 is connected to the first connecting portion 113, the front end portions of all the connecting members 211 extend through the corresponding through slots 13. Such a design avoids the case that the adjusted angle is limited since the through slots 13 correspond one to one with the connecting members 211.

According to another embodiment of the present invention, the number of the through slots 13 is smaller than that of the connecting members 211, and when the second connecting portion 21 is connected to the first connecting portion 113, the front end portions of all the connecting members 211 extend through the corresponding through slots 13. Such a design may also avoid the case that the adjusted angle is limited since the through slots 13 correspond one to one with the connecting members 211.

According to an embodiment of the present invention, the plurality of through slots 13 are arranged at an interval in a circular ring pattern, and the circular ring formed by the plurality of through slots 13 is concentric with the circular ring-shaped first connecting portion 113. Preferably, each of the through slots 13 is in a circular arc shape. Furthermore, when the front end portion 213 of each of the connecting members 211 extends correspondingly through one of the through slots 13, the panel light in a natural state or in a mounted state does not rotate relative to the mounting position. Such a design may ensure that the relative positions of the second connecting portion 21 and the first connecting portion 113 remain stable when an external force is not applied.

According to an embodiment of the present invention, a chamfer is provided on both sides of the front end portion 213 of the connecting member 211 in a rotation direction of the base plate 20. In the present utility model, a height of the chamfer coincides with that of the front end portion 213, that is, the height of the chamfer coincides with the height of the connecting member 211 extending through the through slot 13. At the same time, front and rear sides (corresponding to the rotation direction of the base plate 20) of the front end portion 213 are both provided with a chamfer, so that the base plate 20 rotates smoothly relative to the mounting member 10 in either a clockwise direction or a counterclockwise direction.

Referring to FIG. 2-3, according to another embodiment of the present invention, a fillet 214 is provided on both sides of the front end portion 213 of the connecting member 211 in a rotation direction of the base plate 20. In the present invention, a height of the fillet 214 coincides with that of the front end portion 213, that is, the height of the fillet 214 coincides with the height of the connecting member 211 extending through the through slot 13. At the same time, front and rear sides (corresponding to the rotation direction of the base plate 20) of the front end portion 213 are both provided with a fillet 214, so that the base plate 20 rotates smoothly relative to the mounting member 10 in either a clockwise direction or a counterclockwise direction.

According to a further embodiment of the present invention, a fillet 214 and chamfer are provided on both sides of the front end portion 213 of the connecting member 211 in a rotation direction of the base plate 20. In the present invention, a height of the fillet 214 and chamfer coincides with that of the front end portion 213, that is, the height of the fillet 214 and chamfer coincides with the height of the connecting member 211 extending through the through slot 13. At the same time, front and rear sides (corresponding to the rotation direction of the base plate 20) of the front end portion 213 are respectively provided with the fillet 214 and chamber, so that the base plate 20 rotates smoothly relative to the mounting member 10 in either a clockwise direction or a counterclockwise direction.

Referring to FIG. 3, according to an embodiment of the present invention, a plurality of limiting members 14 extend inwardly at an interval at an upper end of an inner surface of the first connecting portion 113, the limiting members 14 are configured to snap fit with the bosses 212, the plurality of limiting members 14 are all located on the same plane parallel to the second surface 112, the annular groove 114 is located between the plurality of limiting members 14 arranged in a circular ring pattern and the second surface 112.

Alternatively, according to another embodiment of the present invention, the inner surface of the first connecting portion 113 is recessed inwardly to form the annular groove 114, and the plurality of the bosses 212 are all snap-fitted on the annular groove 114.

Referring to FIGS. 3 and 5, according to some embodiments of the present invention, the second surface 112 is further provided with a first positioning ring 15, and the second connecting portion 21 further comprises a second positioning ring 22 connected to the first positioning ring 15, and a reinforcing assembly 23 located between the second positioning ring 22 and the plurality of connecting members 211. When the first connecting portion 113 and the second connecting portion 21 are connected, the first positioning ring 15 is connected in the second positioning ring 22 to achieve mounting and positioning. The reinforcing assembly 23 is used to reinforce the strength of connection between the first connecting portion 113 and the second connecting portion 21.

Referring to FIGS. 3 and 5, according to an embodiment of the present invention, the first positioning ring 15 is preferably concentric with the circular ring-shaped first connecting portion 113, and the second positioning ring 22 is preferably concentric with the circular ring formed by the plurality of connecting members 211.

Referring to FIGS. 3 and 5, according to an embodiment of the present invention, the reinforcing assembly 23 comprises a reinforcing ring 231 concentric with the second positioning ring 22 and a plurality of reinforcing ribs 232 located between the second positioning ring 22 and the plurality of connecting members 211.

Referring to FIGS. 1 and 3, according to an embodiment of the present invention, the mounting member 10 comprises a disc-shaped main body portion 11 and a wing 12 that is connected to the main body portion 11 and assists in detachment. The main body portion 11 comprises the first surface 111 and the second surface 112, and is provided with the first connecting portion 113. The wing 12 is preferably formed by extending outwardly along a side of the main body portion 11, and the wing 12 may increase the contact area of the mounting member 10 with the mounting position upon actual mounting. In addition, when the panel light is removed, the wing 12 may be pressed to prevent the mounting member 10 from disengaging from the mounting position along with the base plate 20. In addition, the wing 12 may also assist in applying a pressure to the mounting position, thereby avoiding occurrence of a gap between the mounting member 10 and the mounting position.

The present invention further provides a panel light, wherein the panel light comprises the aforementioned mounting assembly, wherein the base plate 20 is preferably disposed on a back cover of the panel light. The panel light further comprises a bracket member disposed in the back cover, a circuit board connected to the bracket member, an LED lighting unit electrically connected to the circuit board, and a diffusing sheet and a light shielding sheet attached to the back cover.

According to an embodiment of the present invention, the panel light further comprises a light shielding sheet corresponding to an LED light-emitting unit. At the same time, a touch thin film connected to the circuit board is further disposed in the back cover, and the touch thin film is an aluminum foil paper thin film.

According to an embodiment of the present invention, the shape of the panel lighting apparatus is preferably a regular polygon, for example, preferably at least one selected from a group consisting of a triangular panel light, a quadrilateral panel light, a hexagonal panel light and an octagonal panel light. The LED light-emitting unit is disposed diagonally at the panel light.

The present invention further provides a panel light combination, wherein the panel light combination comprises at least two aforementioned panel lights that are connected in close proximity to each other. According to an embodiment of the present invention, the lighting apparatus may be the aforementioned panel light, or may be a lamp with other structures.

The above is only preferred embodiments of the present invention, and is not intended to limit the present utility model. Any modifications, equivalent substitutions, and improvements made within the spirit and principles of the present utility model should all be included in the protection scope of the present invention.

What is claimed is:

1. A mounting assembly, comprising:
a mounting member including a first surface connectable to a mounting position, a second surface opposite to the first surface, and a generally circular ring-shaped first connecting portion formed by extending outwardly along the second surface; and
a base plate connected to the mounting member, a middle portion of the base plate extending outwardly to form a second connecting portion detachably connected to the first connecting portion;
wherein the first connecting portion is further configured to be movably engaged with the second connecting portion such that can adjust a mounting angle relative to the mounting member is adjustable by the base plate.

2. The mounting assembly according to claim 1, wherein an inner side surface of the first connecting portion is formed with an annular groove, the second connecting portion includes a plurality of connecting members arranged in a circular ring pattern and at an interval, and the connecting members extend outwardly to form bosses, and wherein the bosses are configured such that the base plate is snap-fittable in the annular grooves in a manner rotatable relative to the mounting member.

3. The mounting assembly according to claim 1, wherein an inner side surface of the second connecting portion is formed with an annular groove, the first connecting portion includes a plurality of connecting members arranged in a circular ring pattern and at an interval, and the connecting members extend outwardly to form bosses; wherein the bosses are configured such that the base plate is snap-fittable in the annular grooves in a manner that a position relative to the mounting member is adjustable.

4. The mounting assembly according to claim 2, wherein the mounting member is further provided with a plurality of through slots corresponding to the plurality of connecting members, and wherein the number of the through slots is different from that of the connecting members, and wherein when the second connecting portion is connected to the first connecting portion, front end portions of all the connecting members extend through the corresponding through slots.

5. The mounting assembly according to claim 4, wherein a chamfer or fillet is provided on both sides of the front end portions of the connecting members in a rotation direction of the base plate.

6. The mounting assembly according to claim 2, wherein the connecting members are formed by extending vertically outward along a surface of the base plate, and the bosses are formed by extending in a direction away from a center of the base plate along an external surface of the connecting members.

7. The mounting assembly according to claim 6, wherein the boss comprises an upper slope and a lower slope disposed obliquely relative to a surface of the base plate.

8. The mounting assembly according to claim 1, wherein a plurality of limiting members extend inwardly at an interval at an upper end of an inner surface of the first connecting portion, the limiting members are configured to snap fit with the bosses, the plurality of limiting members are located on the same plane parallel to the second surface, the annular grooves are located between the plurality of limiting members arranged in a circular ring pattern and the second surface.

9. The mounting assembly according to claim 1, wherein the inner surface of the first connecting portion is recessed inwardly to form the annular grooves, and the bosses are all snap-fitted in the annular grooves.

10. The mounting assembly according to claim 1, wherein the second surface is further provided with a first positioning ring, the second connecting portion further comprises a second positioning ring connected to the first positioning ring, and a reinforcing assembly located between the second positioning ring and the plurality of connecting members.

11. The mounting assembly according to claim 10, wherein the first positioning ring is concentric with the circular-ring shaped first connecting portion, and the second positioning ring is concentric with a circular ring formed by the plurality of connecting members.

12. The mounting assembly according to claim 10, wherein the reinforcing assembly includes a reinforcing ring concentric with the second positioning ring and a plurality of reinforcing ribs located between the second positioning ring and the plurality of connecting members.

13. The mounting assembly according to claim 1, wherein the mounting member includes a disc-shaped main body portion and a wing that is connected to the main body portion and assists in detachment; the main body portion comprises the first surface and the second surface, and is provided with the first connecting portion (113).

14. The mounting assembly according to claim 1, wherein the first surface of the mounting member is detachably mounted to the mounting position.

15. The mounting assembly according to claim 14, wherein the first surface of the mounting member is detachably mounted to the mounting position in one of the following manners:
(1) attaching a double-sided adhesive tape on the first surface of the mounting member;
(2) fixing a first magnet on the first surface of the mounting member, and fixing a second magnet on the mounting position;
(3) applying an adhesive on at least one of the first surface and the mounting position; and
(4) disposing a nail, a screw or a bolt on one of the first surface and the mounting position, and a hole or a threaded hole mating therewith is formed on one of the first surface and the mounting position.

16. A panel light comprising a mounting assembly of claim 1.

17. The panel light according to claim 16, wherein the panel light further comprises a back cover, a circuit board disposed in the back cover, a bracket supporting the circuit board, an LED electrically connected to the circuit board, and a touch thin film electrically connected to the circuit board.

18. The panel light according to claim 17, wherein the touch thin film is an aluminum foil paper thin film.

19. The panel light according to claim 16, wherein the panel light is at least one selected from a group consisting of a triangular panel light, a quadrilateral panel light, a hexagonal panel light and an octagonal panel light.

20. A panel light combination, comprising at least two panel lights according to claim 16 and are connected in close proximity to each other.
